(19) United States
(12) Patent Application Publication
(10) Pub. No.: US 2019/0228583 A1
(43) Pub. Date: Jul. 25, 2019

(54) SYSTEMS AND METHODS FOR TRACKING OBJECT LOCATION AND ORIENTATION IN VIRTUAL REALITY ENVIRONMENTS USING ULTRA-WIDEBAND SIGNALS, INERTIA MEASUREMENT UNITS, AND REFLECTIVE MARKERS

(71) Applicant: MassVR, LLC, Schiller Park, IL (US)

(72) Inventors: Chris Lai, Northbrook, IL (US); Steven Daniels, Chicago, IL (US); Cole Coats, Winfield, IL (US); Peter Rakhunov, Chicago, IL (US); John Thomas Wayne, Chicago, IL (US)

(21) Appl. No.: 16/254,244

(22) Filed: Jan. 22, 2019

Related U.S. Application Data
(60) Provisional application No. 62/620,266, filed on Jan. 22, 2018.

(51) Int. Cl. G06T 19/00; G02B 27/01; G06F 3/01; G06T 7/70

(52) U.S. Cl. CPC G06T 19/006; G02B 27/017; G06F 2203/012; G06T 7/70; G06T 2207/30204; G06F 3/011

(57) ABSTRACT

Systems and methods for tracking object location and orientation in VR environments include: fixed position ultra-wideband transceivers transmitting within a physical space and receiving reflections of those transmissions; mobile objects located within the physical space, at least one of the mobile objects including one or more light-reflective tracking markers that reflect the ultra-wideband transmissions of the transceivers; one or more cameras mounted to at least one of the mobile objects, each camera including a wireless communication module; a processor in communication with the transceivers and the wireless communication modules of the cameras; and a memory in communication with the processor, the memory storing program instructions that, when executed by the processor, cause the processor to: calculate the position of each mobile object using the reflections received by the transceivers in combination with the information received from the one or more cameras mounted to each mobile object.

### BACKGROUND OF THE INVENTION

The present subject matter relates generally to systems and methods for tracking users in virtual reality environments. More specifically, the present invention relates to systems and methods for tracking object movement and orientation in a virtual reality environment using ultra-wideband signals and reflective marker systems, structured light cameras, stereoscopic cameras, and inertia measurement units.

Virtual reality (VR) systems are digitally rendered environments in which users immerse themselves in a virtual experience. These environments can be modeled after real or imaginary locations. Current technology allows users to explore these environments using a head-mounted display (HMD), often in conjunction with other equipment such as handheld controllers or movement-tracking clothing. HMDs display a virtual environment in front of the user's eyes. The HMDs can take a variety of forms, such as glasses, goggles, helmets etc. Some systems allow users to explore the virtual world by moving through their physical environment, such movement corresponding to and controlling movement in the virtual world. These real and virtual movements are usually limited in scope and range by the environment in which the user is physically located and by the virtual environment the user is exploring.

Environments in which users are able to physically move around to explore the virtual world require systems and methods through which their location and movements can be tracked. Additionally, systems and methods are required to track the orientation of the user's body as well as any objects used in both the physical and virtual world. This information is used to create a detailed representation of the user in the virtual world (often referred to as an avatar).

Existing systems for determining location and orientation of objects moving throughout a given physical space typically involve the use of passive or active marker-based tracking systems. These systems use a combination of markers affixed to the user's body in conjunction with a fixed, multi-camera system to track the location and the orientation of the user in a one-step process. The markers are placed on trackable objects such as a head-mounted device (HMD), a handheld controller, or on various points of the user's body. The cameras are fixed in the physical space and oriented such that multiple cameras can observe each location a user may explore. Objects are located within the physical space by calculating, via triangulation, the distance between the markers and the multiple cameras. The precision and accuracy of the user tracking and the accuracy of the VR representation of the avatar's movements can be increased by using a greater number of markers and/or a greater number of cameras, each of which increases the system's latency, increases the complexity of the system calibration, and requires additional expense.

Issues arise when markers are not within view of a camera. As users move throughout the space, the cameras' views of certain markers may become obstructed, which makes it difficult to accurately render that object's location. Again, additional cameras can be added to increase the overall field of view, but, as noted above, this creates a complex and costly system with higher latency rates. The great cost and complexity of these camera systems is a significant hurdle to the setup and implementation of VR environments.

Accordingly, there is a need for systems and methods for providing accurate, precise, and low-cost object location and orientation tracking, as described herein.

### BRIEF SUMMARY OF THE INVENTION

To meet the needs described above and others, the present disclosure provides a multi-step process embodied in systems and methods for tracking object location and orientation in virtual reality environments using ultra-wideband signals and reflective marker systems, structured light cameras, stereoscopic cameras, and inertia measurement units (IMUs). In some embodiments, the systems and method further incorporate one or more cameras mounted to the user, rather than fixed in the physical location. The systems and methods are described as incorporating a multi-step system because they separate the location tracking (absolute and relative) and the orientation tracking into discreet problems rather than combining them into a single measurement, as is typical in previously existing systems. Further, the systems and methods taught herein, uses separate tracking systems to identify and track the users' absolute location, relative location, and orientation in the X-Y plane versus those that track the users' along the Z-axis.

The systems and methods provided herein utilize the multi-step process to separately calculate object location in the X-Y plane, object location along the Z-axis, and object orientation with high accuracy and minimal latency. This system corrects inaccuracies caused by positional errors that result from imprecise marker-and-camera technology.

For purposes of this disclosure, VR systems are understood to be a combination of one or more devices through which a VR environment may be displayed to a user and with which the user may explore and interact. Of particular relevance are multi-user VR environments in which multiple users interact within a single VR environment.

A critical component of controlling a VR experience is being able to track the user location and user orientation such each of the location and orientation can be used to place the user in the VR environment and enable the user to experience realistic interactions within the VR environment. Accordingly, it is necessary to track the location and orientation of each user in a physical space so it can be translated into appropriate representations within the virtual environment.

Whereas previously existing systems used a combination of markers affixed to the user's body in conjunction with a fixed, multi-camera system to track the location and the orientation of the user in a single-step process (i.e., the multi-camera system uses the markers to identify position and orientation), the present solution separates the mechanisms for tracking the user position from the mechanisms for tracking the user orientation and further concurrently uses multiple systems adapted to each assess a component of the user tracking process.

Location Tracking in the X-Y Plane

In order to track user location within a physical space associated with a virtual environment, light-reflective tracking markers are attached to various trackable objects. For example, the light-reflective tracking markers can be affixed to a handheld controller, to the top of a head-mounted display (HMD), to the users themselves, or to any other trackable object, as necessary.

In one example, a series of anchors that are spaced along the physical space transmit ultra-wideband signals throughout the physical space. The anchors include both a transmitter module and a receiver module to transmit ultra-wideband signals and receive the signal reflections. The anchors are further in wired or wireless communication with a central processor, which may be local or remote. The reflections of the signals by the light-reflective tracking markers are received by the anchors' receiver modules and the reflected signals are then used to determine the precise location of all users of the virtual reality system. This location data identifying the location of the users within the physical space is then transmitted to the processor where the data is rendered into the virtual environment.

This component of the location tracking system is best adapted for identifying location in the X-Y (horizontal) plane. It is less adept at tracking users along the Z (vertical) axis. It is also best adapted for tracking absolute position using fast, but not necessarily stable readings.

Accordingly, relative position tracking in the X-Y plane can be supplemented using a forward-facing stereoscopic camera located along a user's HMD. Such a camera system can efficiently identify changes in relative position of the user in the X-Y plane to supplement the absolute location obtained from the ultra-wideband signal system.

Location Tracking Along the Z-Axis

In order to track user location along a vertical plane, a structured light camera can be used to detect height along the Z-axis. For example, a camera located in a user's backpack directed downward at an approximately 70-degree angle with respect to the horizon can be used to identify the distance of the user from the ground level. Similarly, a camera can be placed on the HMD, in a similar angle with respect to the horizon.

The combination of the ultra-wideband tracking system for detecting absolute location in the X-Y plane, the user mounted stereoscopic tracking system for detecting relative location in the X-Y plane, and the structured light camera tracking system for detecting location along the Z-axis is a more effective and more efficient tracking system than those provided in previously existing systems.

Orientation Tracking

In order to track user orientation within a physical space associated with a virtual environment, inertia measurement units (IMUs) are incorporated within devices so as to measure the roll, pitch, and yaw of the devices. For example, IMUs may be used in the users' HMDs to measure head orientation. In another example, the IMUs are incorporated into handheld controllers so as to detect the orientation of said devices. The orientation of the devices can be used as proxies for user orientation, which can be a very accurate proxy, particularly when using IMUs in the users' HMDs. It is contemplated that IMUs may be incorporated in any such device that may be useful in determining the orientation of the user.

In addition to the location tracking and orientation tracking described above, a camera may be attached to each user's head-mounted device (HMD). The camera may be aimed in such a way that the user's motions are visible within the camera's field of view. In such an orientation, the camera can be used to capture the motion and orientation of the user's body, thereby supplementing or replacing the orientation tracking described above with respect to the IMUs.

Alternatively, or additionally, each user's HMD may include a camera oriented to detect the reflections provided by the light-reflective tracking markers. The captured reflections can be transmitted back to the processor to aid in location tracking. For example, this location information can be used independently or in conjunction with the location of the user obtained by the ultra-wide band anchor transmitters/receivers to provide accurate and precise user location information.

The same camera and camera orientation may be used for both the location tracking and orientation tracking functions described above, or two or more cameras or camera orientations may be employed, as will be understood by those skilled in the art.

Thus, using a combination of: (1) light-reflective tracking markers and ultra-wideband signals transmitter/receivers (anchors and/or cameras); (2) one or more user-mounted stereoscopic, or structured light, cameras; and (3) one or more devices incorporating IMUS in communication with the processor, the system may accurately and precisely track user location and orientation in a low-cost, multi-step process. Additionally, user mounted camera may be substituted into this multi-step process to assist in either the location tracking or orientation tracking or both, or the user mounted cameras may act as supplemental data collection mechanisms for location tracking, orientation tracking, or both.

In one example, A system for tracking object location and orientation in virtual reality environments includes: a plurality of fixed position ultra-wideband transceivers transmitting within a physical space and receiving reflections of those transmissions; one or more mobile objects located within the physical space, at least one of the mobile objects including one or more light-reflective tracking markers that reflect the ultra-wideband transmissions of the transceivers; one or more cameras mounted to at least one of the mobile objects, each camera including a wireless communication module; a processor in communication with the transceivers and the wireless communication modules of the cameras; and a memory in communication with the processor, the memory storing program instructions that, when executed by the processor, cause the processor to: calculate the position of each mobile object using the reflections received by the transceivers in combination with the information received from the one or more cameras mounted to each mobile object.

One or more of the mobile objects may be head-mounted displays. One or more of the mobile objects may be objects worn by one or more users. One or more of the mobile objects may be objects carried by one or more users.

The instructions executed by the processor may further cause the processor to calculate the position of at least one mobile object using information captured by the one or more cameras and communicated to the processor.

The instructions executed by the processor may further cause the processor to identify the orientation of at least one mobile object using data collected by the one or more cameras and communicated to the processor.

The plurality of fixed position ultra-wideband transceivers may be fixed along an outer perimeter of the physical space.

The users of the system may each be equipped with a corresponding mobile object including a head-mounted display, at least one light-reflective tracking marker, and at least one camera.

The users of the system may each be equipped with a corresponding mobile object including at least one light-reflective tracking marker and at least one inertial measurement unit.

The users of the system may each be equipped with a first mobile object including at least one light-reflective tracking marker and a second mobile object including at least one camera.

An object of the invention is to provide cost effective and accurate systems and methods for tracking object location and orientation in virtual reality environments.

Another object of the invention is to track object location and orientation in virtual reality environments without relying on a network of fixed position cameras.

An advantage of the solutions provided herein is the multi-step process provided by the solution described herein decouples object location tracking from object orientation tracking.

Another advantage of the solutions provided herein is it is the systems are easily scalable.

Additional objects, advantages, and novel features of the solutions provided herein will be recognized by those skilled in the art based on the following detail description and claims, as well as the accompanying drawings, and/or may be learned by production or operation of the examples provided herein.

### BRIEF DESCRIPTION OF THE DRAWINGS

The figures depict one or more embodiments of the subject matter described herein. They are provided as examples only. Within the figures, reference numbers are used to refer to elements described in the detailed description.

FIG. 1 is a schematic diagram illustrating examples of components of a system for tracking users in virtual reality environments.

FIG. 2 is a schematic diagram illustrating further examples of components of a system for tracking users in virtual reality environments.

FIG. 3 is flow chart representing an example of a method for tracking users in virtual reality environments.

FIG. 4 is flow chart representing a further example of a method for tracking users in virtual reality environments.

### DETAILED DESCRIPTION OF THE INVENTION

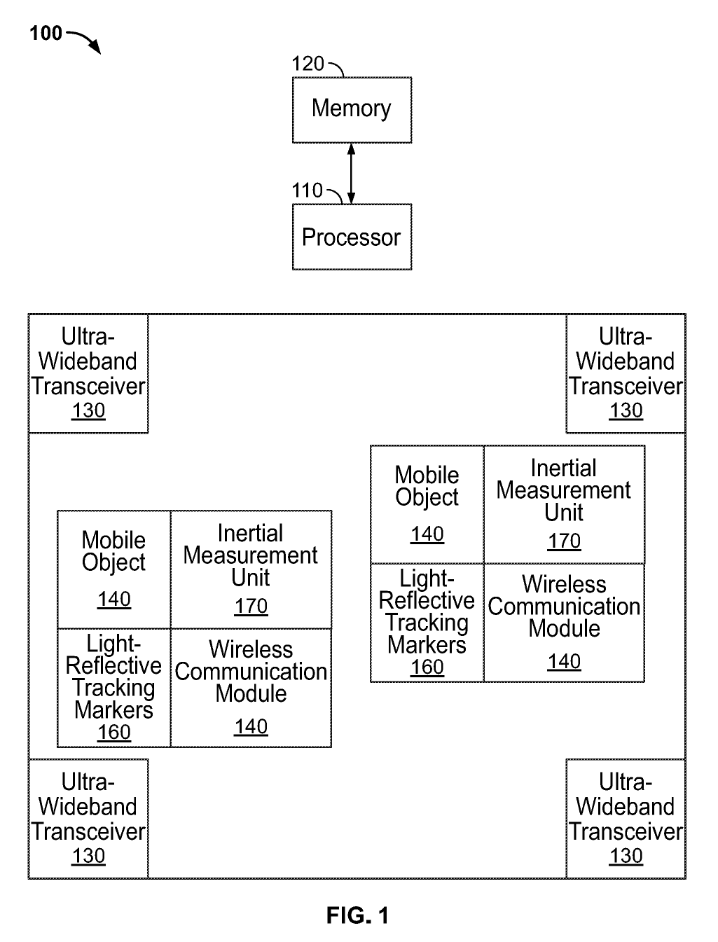

FIG. 1 illustrates a system 100 for tracking users in virtual reality environments. The system 100 shown in FIG. 1 is an example of a system 100 in which the location tracking (absolute and relative) and the orientation tracking are separated into discreet problems, thereby improving accuracy and minimizing latency compared to previously known systems.

In the embodiment illustrated in FIG. 1, the system 100 includes: a processor 110, memory associated with the processor 120, a plurality of fixed position ultra-wideband transceivers 130, mobile objects 140 located within a physical space 150, the mobile objects 140 including one or more light-reflective tracking markers 160 to reflect the ultra-wideband transmissions of the transceivers; and one or more inertial measurement units 170 mounted to, or in, at least one of the mobile objects 140, each inertial measurement unit 170 including a wireless communication module 180.

In the example shown in FIG. 1, the ultra-wideband transceivers 130 transmit their frequencies through the physical space 150, the transmissions are reflected off of the light-reflective tracking markers 160, and the reflected transmissions are received by the transceivers 130. The transceivers 130 communicate the information collected in the transmission/reflection process to the processor 110. Using the information collected from the various transceivers 130, the processor 110 is able to calculate the position of each mobile object 140 in the physical space 150.

In addition, in the example shown, the mobile objects 140 include inertial measurement units 170 that communicate with the processor 110 through their wireless communication modules 180. The inertial measurement units 170 measure the roll, pitch, and yaw of the mobile objects 140, which, when communicated to the processor 110, enables the processor 110 to calculate the orientation of the mobile objects 140.

In a principle example, the physical space 150 is an arena in which users engage with a VR environment. The quality of the users' VR experience depends directly on the speed and accuracy their movements are represented in the VR environment and even marginal gains in either can be perceived by a user. Accordingly, by using the ultra-wideband transceivers 130 to determine the X-Y positioning of the users (e.g., using the transmissions reflected from the ultra-wideband transceivers 130 by the light-reflective tracking markers 160 affixed to the users or to items worn or held by the users) and separately using the inertial measurement units 170 to determine the orientation of the user (e.g., an inertial measurement unit 170 worn in a user's helmet can identify the orientation of the user's view), both speed and accuracy in measurement and representation are improved over the prior known systems.

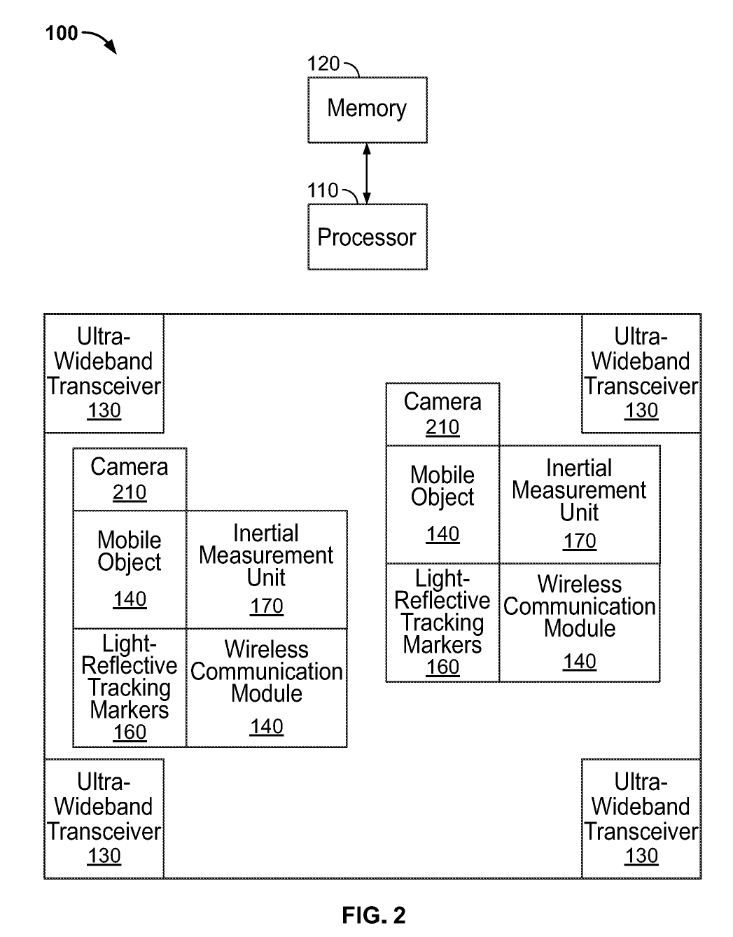

FIG. 2 illustrates another embodiment of a system 100 for tracking users in virtual reality environments. In the embodiment illustrated in FIG. 2, the system 100 further includes one or more cameras 210 associated with each mobile object 140. For example, a stereoscopic camera 210 may be attached to each user's head-mounted device (HMD), the HMD being an example of a mobile object 140. The camera 210 may be aimed in such a way that the user's motions are visible within the camera's field of view. In such an orientation, the camera 210 can be used to capture the motion and orientation of the user's body, thereby supplementing or replacing the orientation tracking described above with respect to FIG. 1.

Alternatively, or additionally, each user's HMD 140 may include a camera 210 oriented to detect the reflections provided by the light-reflective tracking markers 160. The captured reflections can be transmitted back to the processor 110 to aid in location tracking. For example, this location information can be used independently or in conjunction with the location of the user obtained by the ultra-wide band transceivers 130 to provide accurate and precise user location information.

Alternatively, or additionally, each user's HMD 140 may include a camera 210 oriented to accomplish relative position tracking in the X-Y plane. Such a camera system can efficiently identify changes in relative position of the user in the X-Y plane to supplement the absolute location obtained from the ultra-wideband signal system. For example, a stereoscopic camera may be mounted to each users' HMD 140 looking forward into what would be the user's field of view to help identify relative position of the user.

Alternatively, or additionally, each user's HMD 140 may include a camera 210 oriented to detect the user's height along the Z-axis. For example, in order to track user location along a vertical plane, a structured light camera can be used to detect height along the Z-axis. Such a camera 210 may be located in a user's backpack directed downward at an approximately 70-degree angle with respect to the horizon to identify the distance of the user from the ground level. Similarly, a camera 210 can be placed on the HMD, in a similar angle with respect to the horizon.

The combination of the ultra-wideband tracking system for detecting absolute location in the X-Y plane, the user mounted stereoscopic tracking system for detecting relative location in the X-Y plane, and the structured light camera tracking system for detecting location along the Z-axis is a more effective and more efficient tracking system than those provided in previously existing systems.

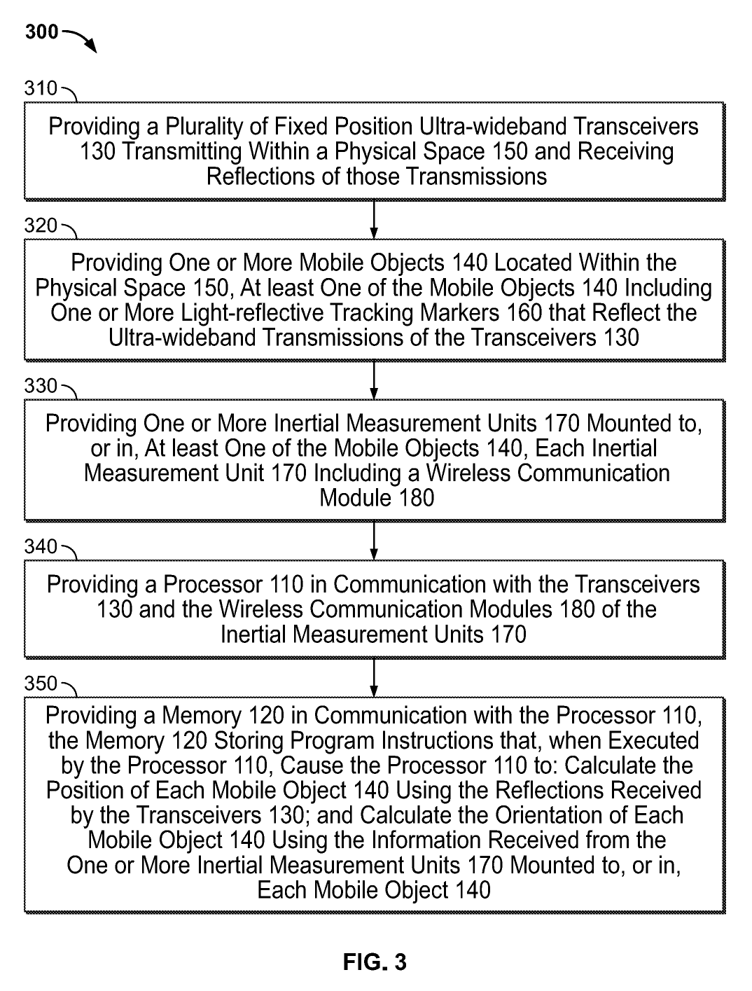

FIG. 3 is a flow chart representing an example of a method 300 for tracking users in virtual reality environments. In the example shown in FIG. 3, the method 300 includes the following steps:

Step 310: providing a plurality of fixed position ultra-wideband transceivers 130 transmitting within a physical space 150 and receiving reflections of those transmissions.

Step 320: providing one or more mobile objects 140 located within the physical space 150, at least one of the mobile objects 140 including one or more light-reflective tracking markers 160 that reflect the ultra-wideband transmissions of the transceivers 130.

Step 330: providing one or more inertial measurement units 170 mounted to, or in, at least one of the mobile objects 140, each inertial measurement unit 170 including a wireless communication module 180.

Step 340: providing a processor 110 in communication with the transceivers 130 and the wireless communication modules 180 of the inertial measurement units 170.

Step 350: providing a memory 120 in communication with the processor 110, the memory 120 storing program instructions that, when executed by the processor 110, cause the processor 110 to: calculate the position of each mobile object 140 using the reflections received by the transceivers 130; and calculate the orientation of each mobile object 140 using the information received from the one or more inertial measurement units 170 mounted to, or in, each mobile object 140.

Accordingly, as shown in FIG. 3, the combination of the ultra-wideband transceivers 130 and light-reflective tracking markers 160 enables the tracking the location of the one or more mobile objects 140 within the physical space 150. The use of the one or more inertial measurement units 170 enables the tracking of the orientation of the mobile objects. When light-reflective tracking markers 160 are used on the users in the virtual reality environments and the inertial measurement units 170 are used in their HMDs 140, the systems and methods enable the accurate tracking of each user's positions and view orientation.

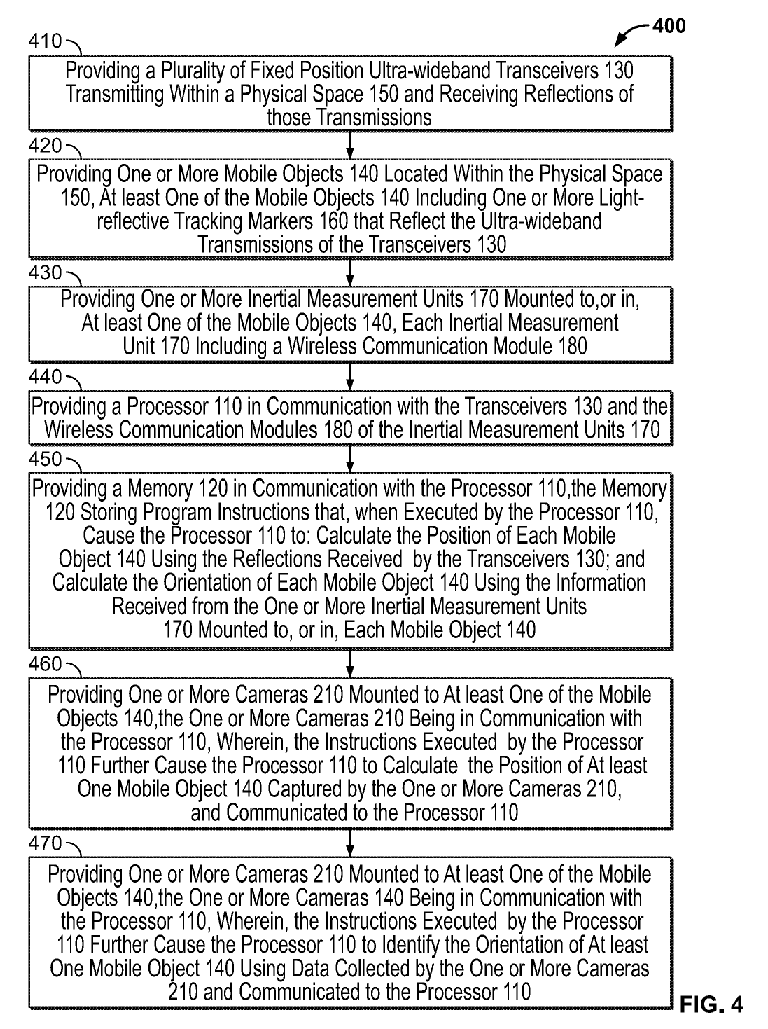

FIG. 4 is a flow chart representing another example of a method 300 for tracking users in virtual reality environments. In the example shown in FIG. 3, the method 300 includes the following steps:

Step 410: providing a plurality of fixed position ultra-wideband transceivers 130 transmitting within a physical space 150 and receiving reflections of those transmissions.

Step 420: providing one or more mobile objects 140 located within the physical space 150, at least one of the mobile objects 140 including one or more light-reflective tracking markers 160 that reflect the ultra-wideband transmissions of the transceivers 130.

Step 430: providing one or more inertial measurement units 170 mounted to, or in, at least one of the mobile objects 140, each inertial measurement unit 170 including a wireless communication module 180.

Step 440: providing a processor 110 in communication with the transceivers 130 and the wireless communication modules 180 of the inertial measurement units 170.

Step 450: providing a memory 120 in communication with the processor 110, the memory 120 storing program instructions that, when executed by the processor 110, cause the processor 110 to: calculate the position of each mobile object 140 using the reflections received by the transceivers 130; and calculate the orientation of each mobile object 140 using the information received from the one or more inertial measurement units 170 mounted to, or in, each mobile object 140.

Step 460: providing one or more cameras 210 mounted to at least one of the mobile objects 140, the one or more cameras 210 being in communication with the processor 110, wherein, the instructions executed by the processor 110 further cause the processor 110 to calculate the position of at least one mobile object 140 captured by the one or more cameras 210 and communicated to the processor 110.

Step 470: providing one or more cameras 210 mounted to at least one of the mobile objects 140, the one or more cameras 210 being in communication with the processor 110, wherein, the instructions executed by the processor 110 further cause the processor 110 to identify the orientation of at least one mobile object 140 using data collected by the one or more cameras 210 and communicated to the processor 110.

Accordingly, the method 300 shown in FIG. 4 can combine the use of ultra-wideband transceivers 130 and light-reflective tracking markers 160 for detecting users' absolute locations in the X-Y plane, inertial measurement units 170 to track the user's visual orientation, user mounted stereoscopic tracking cameras 210 for detecting each user's relative location in the X-Y plane, and the structured light cameras 210 for detecting each user's location along the Z-axis for a complete, wholistic, low latency, high accuracy, user tracking system and method.

It should be noted that various changes and modifications to the presently preferred embodiments described herein will be apparent to those skilled in the art. Such changes and modifications may be made without departing from the spirit and scope of the present invention and without diminishing its attendant advantages.

1. A system for tracking object location and orientation in virtual reality environments comprising:
a plurality of fixed position ultra-wideband transceivers transmitting within a physical space and receiving reflections of those transmissions;
one or more mobile objects located within the physical space, at least one of the mobile objects including one or more light-reflective tracking markers that reflect the ultra-wideband transmissions from the transceivers back to the transceivers;
one or more cameras mounted to at least one of the mobile objects, each camera including a wireless communication module;
a processor in communication with the transceivers and the wireless communication modules; and
a memory in communication with the processor, the memory storing program instructions that, when executed by the processor, cause the processor to:
calculate the position of each mobile object using input received from the transceivers in combination with input received from the wireless communication modules.

2. The system of claim 1, wherein one or more of the mobile objects are head-mounted displays.

3. The system of claim 1, wherein one or more of the mobile objects are objects worn by one or more users.

4. The system of claim 1, wherein one or more of the mobile objects are objects carried by one or more users.

5. The system of claim 1, wherein the instructions executed by the processor further cause the processor to calculate the position of at least one mobile object using the input received from the wireless communication modules.

6. The system of claim 1, wherein the instructions executed by the processor further cause the processor to identify the orientation of at least one mobile object using the input received from the wireless communication modules.

7. The system of claim 1, wherein the plurality of fixed position ultra-wideband transceivers is fixed along an outer perimeter of the physical space.

8. The system of claim 1, wherein users of the system are each equipped with a corresponding one of the mobile objects, the corresponding one of the mobile objects including a head-mounted display, at least one of the light-reflective tracking markers, and at least one of the one or more cameras.

9. The system of claim 1, wherein users of the system are each equipped with a corresponding one of the mobile objects, the corresponding one of the mobile objects including at least one of the light-reflective tracking markers and at least one inertial measurement unit.

10. The system of claim 1 wherein users of the system are each equipped with a first mobile object including at least one of the light-reflective tracking markers and a second mobile object including at least one of the one or more cameras.

11. A method of tracking object location and orientation in virtual reality environments, the method comprising the steps of:
providing a plurality of fixed position ultra-wideband transceivers transmitting within a physical space and receiving reflections of those transmissions;
providing one or more mobile objects located within the physical space, at least one of the mobile objects including one or more light-reflective tracking markers that reflect the ultra-wideband transmissions of the transceivers;
providing one or more cameras mounted to at least one of the mobile objects, each camera including a wireless communication module;
providing a processor in communication with the transceivers and the wireless communication modules of the cameras; and
providing a memory in communication with the processor, the memory storing program instructions that, when executed by the processor, cause the processor to:
calculate the position of each mobile object using the reflections received by the transceivers in combination with the information received from the wireless communication modules of the one or more cameras.

12. The method of claim 11 wherein one or more of the mobile objects are head-mounted displays.

13. The method of claim 11 wherein one or more of the mobile objects are objects worn by one or more users.

14. The method of claim 11 wherein one or more of the mobile objects are objects carried by one or more users.

15. The method of claim 11 wherein the instructions executed by the processor further cause the processor to calculate the position of at least one mobile object using information captured by the one or more cameras and communicated to the processor by the wireless communication modules of the one or more cameras.

16. The method of claim 11 wherein the instructions executed by the processor further cause the processor to identify the orientation of at least one mobile object using information captured by the one or more cameras and communicated to the processor by the wireless communication modules of the one or more cameras.

17. The method of claim 11 wherein the plurality of fixed position ultra-wideband transceivers is fixed along an outer perimeter of the physical space.

18. The method of claim 11 wherein users of the system are each equipped with a corresponding one of the mobile objects, the corresponding one of the mobile objects including a head-mounted display, at least one of the light-reflective tracking markers, and at least one of the one or more cameras.

19. The method of claim 11 wherein users of the system are each equipped with a corresponding one of the mobile objects, the corresponding one of the mobile objects including at least one of the light-reflective tracking markers and at least one inertial measurement unit.

20. The method of claim 11 wherein users of the system are each equipped with a first mobile object including at least one of the light-reflective tracking markers and a second mobile object including at least one of the one or more cameras.
